(19) United States
(12) Patent Application Publication
(10) Pub. No.: US 2008/0179312 A1
(43) Pub. Date: Jul. 31, 2008

(54) HEATER CONTROLLER

(75) Inventor: Kyozo TERAO, Ozu-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: PANASONIC EV ENERGY CO., LTD., Kosai-shi (JP)

(21) Appl. No.: 11/950,051

(22) Filed: Dec. 4, 2007

(30) Foreign Application Priority Data
Dec. 4, 2006 (JP) 2006-326955

(51) Int. Cl. H05B 1/02

(52) U.S. Cl. 219/497

(57) ABSTRACT

A heater controller that ensures required characteristics and operation for a control rectifying element even in a freezing environment. The control rectifying element is for connection to a heater and an AC power supply for supplying AC voltage to the heater, in which the control rectifying element controls the supply of AC voltage to the heater. The control unit outputs a pulse signal for serving as a trigger for holding the control rectifying element in an activated state based on a zero-cross timing of the AC voltage. When the control rectifying element is not held in the activated state by the pulse signal output from the control unit at the zero-cross timing, the control unit delays the output of the pulse signal from the zero-cross timing while keeping the pulse width of the pulse signal constant until the control rectifying element is held in the activated state.

### CROSS-REFERENCE TO RELATED APPLICATIONS

This application is based upon and claims the benefit of priority from the prior Japanese Patent Application No. 2006-326955, filed on Dec. 4, 2006, the entire contents of which are incorporated herein by reference.

### BACKGROUND OF THE INVENTION

The present invention relates to a heater controller, and more particularly, to a heater controller free of a transformer and suitable for use in freezing environments.

A controller, which is free of a transformer and controls a load such as a heater with a triac, lowers and directly rectifies a power supply voltage. The watt value of the breeder resistor must be increased to prevent current ripple in order for an analog circuit that detects the load state to function accurately. When the ambient temperature decreases to −40° C., the current held at the gate of the triac becomes approximately two times greater than that under normal temperatures. This requires the use of a wide trigger pulse. Accordingly, when used in freezing environments, the watt value of the breeder resistor must be further increased.

In a controller that is free of a transformer, the load and triac are connected in series to an AC power supply. Japanese Laid-Open Patent Publication No. 58-182724 describes a controller, which is free of a transformer, for reducing power consumption with a simple circuit. In the controller described in the publication, a load and triac are connected in series to an AC power supply. Further, a capacitor and a control switching element are connected in series between the gate of the triac and an opposing gate. More specifically, one end of the capacitor is connected to the gate of the triac, and the other end of the capacitor is connected in series to a thyristor. Further, the thyristor and a rectifying element (diode) are in inverse parallel connection.

In a zero-cross type temperature control circuit, the temperature of the controlled subject is detected as a voltage value, and the voltage value (detected temperature) is compared with a reference voltage (reference temperature). In such a zero-cross type temperature control circuit, a zero-cross detection circuit generates a zero-cross pulse used as a trigger by a control rectifying element when the detected temperature is lower than the reference temperature. That is, when the detected temperature is greater than the reference temperature, the control rectifying element is not triggered by the zero-cross pulse. Japanese Laid-Open Patent Publication No. 59-149770 proposes a zero-cross type temperature control circuit that suppresses unnecessary power consumption when using a thyristor as a control rectifying element.

Under a condition in which the ambient temperature decreases to −40° C., the watt value of the breeder resistor must be increased to generate gate hold current that keeps the triac activated in a preferable manner. This enlarges the breeder resistor. Further, the power consumption of the controller increases, and the entire controller is enlarged.

The object of the control circuit in the above publication is to reduce power consumption. However, the publication does not consider a condition under which the ambient temperature decreases to −40° C. Further, Japanese Laid-Open Patent Publication No. 58-182724 describes a device in which a control rectifying element (thyristor and diode) is necessary in addition to a triac that is connected in series to the load.

### SUMMARY OF THE INVENTION

The present invention provides a heater controller that ensures required characteristics and operation for a control rectifying element even in a freezing environment without increasing the watt value of a breeder resistor used in a power supply free of a transformer.

One aspect of the present invention is a heater controller for connection to an AC power supply and for controlling a heater. The heater controller includes a control rectifying element connectable to the heater and AC power supply in which the control rectifying element controls the supply of AC voltage to the heater. A control unit, connected to the control rectifying element, outputs a pulse signal that serves as a trigger for holding the control rectifying element in an activated state based on a zero-cross timing of the AC voltage. The pulse signal has a pulse width. When the control rectifying element is not held in an activated state by the pulse signal output from the control unit at the zero-cross timing, the control unit delays the output of the pulse signal from the zero-cross timing while keeping the pulse width of the pulse signal constant until the control rectifying element is held in an activated state.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic circuit diagram of a heater controller according to a preferred embodiment of the present invention;

FIG. 2 is a schematic flowchart illustrating a heater control executed by a microcomputer shown in FIG. 1;

FIG. 3 is a time chart showing the relationship of the value of the current that flows through a heater (upper row), the application timing of a gate pulse (middle row), and the power supply voltage (lower row); and

FIG. 4 is a graph showing the relationship between a triac gate holding current and the ambient temperature.

### DETAILED DESCRIPTION OF THE PREFERRED EMBODIMENTS

In the drawings, like numerals are used for like elements throughout.

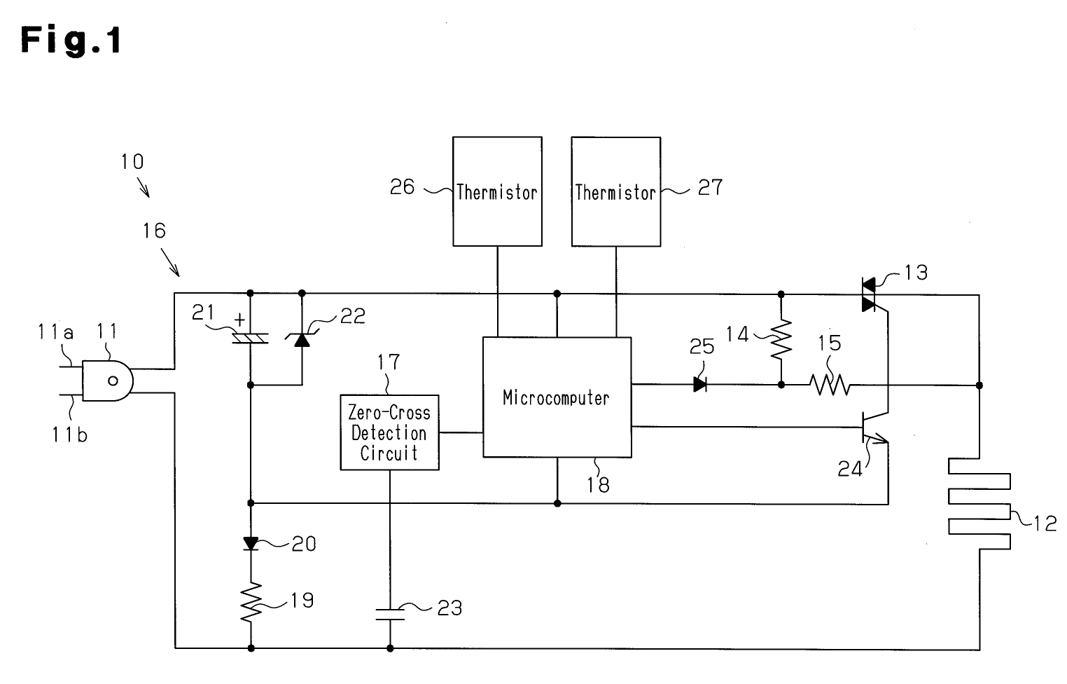

A heater controller 10 according to a preferred embodiment of the present invention will now be discussed with reference to FIG. 1 to 4.

With reference to FIG. 1, the heater controller 10 includes a plug 11, which is connected to a socket (not shown) serving as an alternative current (AC) power supply. The plug 11 includes a voltage blade 11a, which is connected to a voltage terminal of the socket, and a ground blade 11b, which is connected to ground terminal of the socket. A heater 12 and a triac 13 are connected in series to the plug 11. The triac 13 functions as a control rectifying element for controlling activation of the heater 12. Series-connected resistors 14 and 15 are connected in parallel to the triac 13.

The heater controller 10 includes a power supply circuit 16, a zero-cross detection circuit 17, and a microcomputer 18.

The power supply circuit 16 includes a breeder resistor (voltage reducing resistor) 19, a diode 20, and a capacitor 21, which are connected in series. A Zener diode is connected in parallel to the capacitor 21.

The microcomputer 18 is connected in parallel to the capacitor 21. The zero-cross detection circuit 17, which is connected to the voltage blade 11a via a capacitor 23, provides the microcomputer 18, with a zero-cross detection signal. The microcomputer 18 is connected to the base of a transistor 24, which functions as a switching element. An NPN transistor is used as the transistor 24. The transistor 24 has a collector, which is connected to the gate of the triac 13, and an emitter, which is connected to the anode of the diode 20.

The microcomputer 18 is connected via a diode 25 to a node between the resistor 14 and resistor 15. More specifically, the diode 25 has an anode connected to the microcomputer 18 and a cathode connected to a node between the resistor 14 and resistor 15. The resistors 14 and 15 and the diode 25 form a voltage detection unit for detecting the voltage between the two terminals of the triac 13. The microcomputer 18 is connected to a thermistor 26, which functions as a heater temperature detection unit for detecting the temperature of the heater 12, and a thermistor 27, which functions as a board temperature detection unit for detecting the temperature of a printed circuit board. The temperature of the printed circuit board corresponds to the ambient temperature of the heater controller 10. The microcomputer 18 checks the heater temperature and the board temperature. The printed circuit board refers to a circuit board to which elements forming the heater controller 10 such as the triac 13, the power supply circuit 16, the zero-cross detection circuit 17, and the microcomputer 18 are connected.

The microcomputer 18 forms a control unit that generates a pulse signal for triggering, or driving, the triac 13 based on a zero-cross timing (zero-cross point) at which AC voltage is supplied from an AC power supply. More specifically, at an AC voltage zero-cross timing, the microcomputer 18 outputs a pulse signal for triggering the triac 13 as an ON signal for the transistor 24. However, the triac 13 may not be held in an activated state due to the pulse signal output at the zero-cross timing. In this case, the microcomputer 18 delays the timing at which the pulse signal is output from the zero-cross timing while keeping the pulse width of the pulse signal constant. Preferably, the microcomputer 18 continues to delay the timing for outputting the pulse signal from the zero-cross timing by predetermined periods (predetermined first periods) whenever detecting the zero-cross timing until the triac is held in the activated state. After the pulse signal holds the triac 13 in the activated state, the microcomputer 18 shortens the delay time td for outputting the pulse signal by predetermined periods (predetermined second periods) whenever detecting the zero-cross timing. The predetermined first and second periods may be the same or differ from each other.

The operation of the heater controller 10 will now be discussed.

When the plug 11 is connected to the socket, the heater controller 10 is powered. As a result, the zero-cross detection circuit 17 provides the microcomputer 18 with the zero-cross detection signal. The microcomputer 18 determines whether or not the power supply voltage is in an overvoltage state and shifts to an idle state when the power supply voltage is in the overvoltage state. When the power supply voltage is not in an overvoltage state, the microcomputer 18 executes trigger drive control on the triac 13 based on the zero-cross detection signal. When the triac 13 is not activated even though power is applied to the triac 13, current does not flow to the heater 12 via the triac 13. Thus, the power supply voltage is directly applied to the resistors 14 and 15. This enables the microcomputer 18 to determine whether or not the power supply voltage is in an overvoltage state. An overvoltage state refers to a state in which the activation of the triac 13 would result in the current flowing to the breeder resistor 19 exceeding a specified value. An idle state refers to a state in which an operation for outputting the pulse signal for activating the triac 13 is not performed even though the microcomputer 18 receives the zero-cross detection signal from the zero-cross detection circuit 17. Thus, in the idle state, the base of the transistor 24 is not provided with a drive signal, and trigger current does not flow to the triac 13.

Based on the detection signals of the thermistors 26 and 27, the microcomputer 18 executes the trigger drive control on the triac 13 when the temperature of the heater 12 is less than or equal to the set temperature HTu and the temperature of the circuit board is less than or equal to a first set temperature KT1. Thus, heating is not performed when the temperature of the heater 12 is greater than the set temperature HTu or when the temperature of the circuit board is greater than the first set temperature KT1.

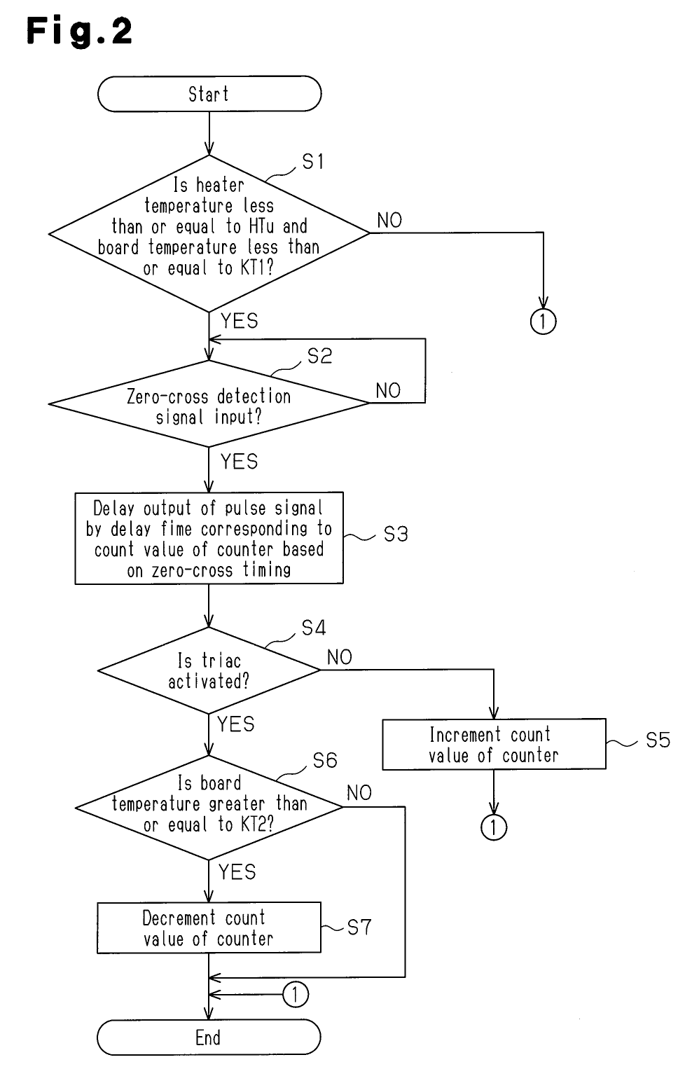

The heater control executed by the microcomputer 18 will now be discussed with reference to FIG. 2. In a non-overvoltage state, the microcomputer 18 performs the process illustrated in the flowchart of FIG. 2 in predetermined cycles that is shorter than one half the AC cycle. The microcomputer 18 executes the heater control so that the zero-cross is detected once during each cycle.

In step S1, the microcomputer 18 determines from the detection signals of the thermistors 26 and 27 whether or not the heater temperature is less than or equal to the temperature HTu and the board temperature is less than or equal to the temperature KT1. If the determination is NO, the microcomputer 18 terminates the processing. If the determination is YES, the microcomputer 18 proceeds to step S2. In step S2, the microcomputer 18 determines whether or not the zero-cross detection signal has been received. If the zero-cross detection signal has been received, the microcomputer 18 proceeds to step S3.

In step S3, the microcomputer 18 provides the base of the transistor 24 with a pulse signal that is delayed by the delay time td, which corresponds to a count value of a counter taken from zero-cross timing. Subsequently, the microcomputer 18 proceeds to step S4. The counter is arranged in, for example, the microcomputer 18. The delay time td is obtained by multiplying the count value of the counter by a predetermined time Δt (predetermined first period). The counter increments its count value if the triac 13 is not held in an activated state even though the gate of the triac 13 is supplied with the trigger current. In an initial state, the count value is zero. The predetermined time Δt is the time for applying the power supply voltage to the triac 13. The predetermined time Δt is set so that when the gate of the triac 13 is provided with a trigger pulse delayed from the zero-cross timing by a delay time that is several times greater than the time Δt under a freezing temperature such as −40° C., the triac 13 enables the flow of current that is greater than the holding current. For example, the predetermined time Δt is set to approximately 100 microseconds.

While the base of the transistor 24 is being provided with the pulse signal, the transistor 24 is held in an activated state, and trigger current flows to the gate of the triac 13. In this state, the trigger current flowing to the gate of the triac 13 holds the triac 13 in an activated state. When current greater than the holding current flows to the triac 13, the triac 13 is held in an activated state even if the gate of the triac 13 is not supplied with the trigger current. In other words, the triac 13 is deactivated when there is no flow of current that is greater than or equal to the holding current. As shown in the graph of FIG. 4, the amount of the holding current varies depending on the ambient temperature. Under a freezing temperature such as minus 40° C., the holding current becomes about two times greater than that under a normal temperature. Thus, under a freezing temperature, the triac 13 is not held in an activated state even if the gate of the triac 13 is supplied with trigger current, which has a pulse width corresponding to a normal temperature. That is, the triac 13 is substantially not activated. In FIG. 4, the vertical axis shows values obtained by dividing the value of the holding current under the ambient temperature by the value of the holding current under a normal temperature (25° C.).

In step S4, the microcomputer 18 determines whether or not the triac 13 is activated. If the triac 13 is not activated, the microcomputer 18 proceeds to step S5, increments the count value of the counter, and then terminates the processing. If the triac 13 is activated, the microcomputer 18 proceeds to step S6. When the heater controller 10 is powered under a freezing temperature, the triac 13 is first not activated. Thus, the microcomputer 18 increments the count value of the counter. The microcomputer 18 determines whether or not the triac 13 is activated by referring to changes in the voltage at the node between the resistors 14 and 15, which are connected in parallel to the triac 13.

In step S6, the microcomputer 18 determines whether or not the board temperature is greater than or equal to the second set temperature KT2. The microcomputer 18 terminates the processing when the board temperature is less than the set temperature KT2 and proceeds to step S7 when the board temperature is greater than or equal to the set temperature KT2. In step S7, the microcomputer 18 decrements the count value of the counter and then terminates the processing.

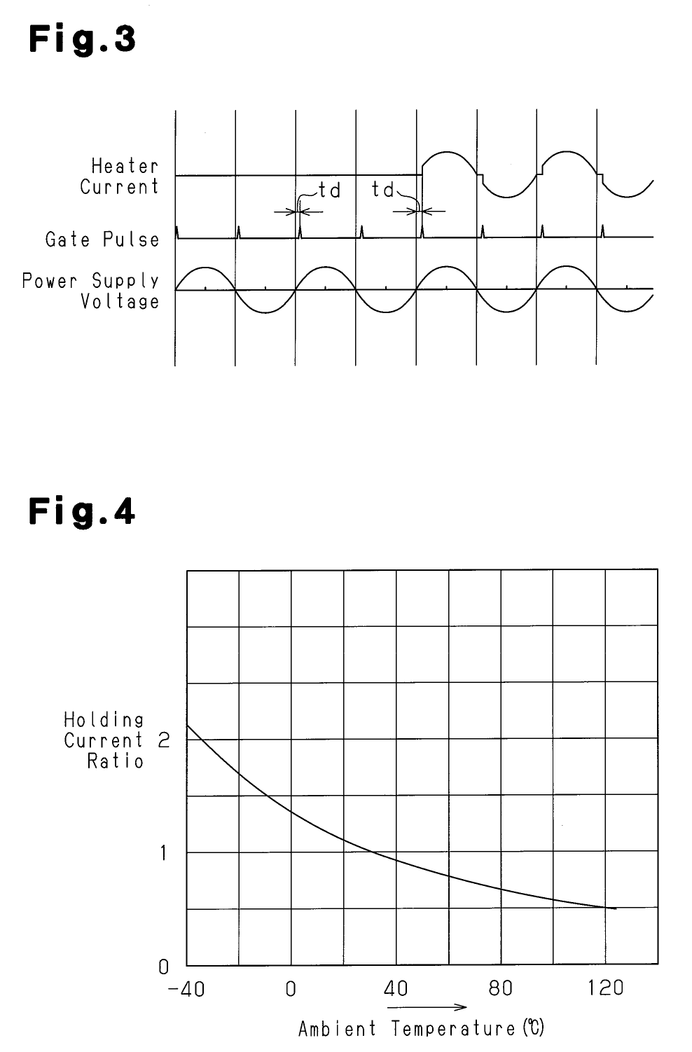

When the microcomputer 18 immediately provides the pulse signal to the transistor 24 in response to the zero-cross detection signal, as shown in FIG. 3, the power supply voltage applied to the triac 13 is small if a trigger pulse is applied to the triac 13. In this state, current that is smaller than the holding current under a freezing temperature momentarily flows through the triac 13. Thus, the triac 13 is not activated, and current substantially does not flow to the heater 12. FIG. 3 shows the relationship of the value of the current that flows through the heater 12 (upper row), the application timing of a gate pulse (middle row), and the power supply voltage (lower row).

The microcomputer 18 repeats the processing of FIG. 2 a number of times. As the delay in the pulse signal output from the zero-cross timing gradually increases, the power supply voltage that is applied to the triac 13 at the moment the trigger pulse is applied to the triac 13 is increased. As a result, current that is greater than the holding current for a freezing temperature flows to the triac 13. Accordingly, current flows to the heater 12. FIG. 3 shows an example in which the counter increments the count value four times, and the triac 13 is held in an activated state when the fifth pulse signal is output thereby causing current to flow to the heater 12.

As shown in FIG. 3, after the triac 13 is held in an activated state by the trigger pulse applied to the gate of the triac 13, the pulse signal is output in a state delayed from the zero-cross timing by the same delay time td. Accordingly, the triac 13 is activated by the trigger pulse and held in an activated state. Self-loss of the triac 13 when held in an activated state gradually warms the triac 13. Accordingly, the triac 13 can be held in an activated state with the trigger pulse even if the output timing of the pulse signal is varied every certain interval to approach the zero-cross timing. This reduces power consumption and enables steps S6 and S7 to be performed. The set temperature KT2 is set to satisfy the conditions for returning the output timing to the zero-cross timing, that is, to a value corresponding to the ambient temperature of the triac 13 when the triac 13 is held in an activated state.

The heater controller 10 of the preferred embodiment has the advantages described below.

(1) The heater controller 10 includes the control rectifying element (triac 13). The control rectifying element is connected in series to the heater, which is connected to the AC power supply, and controls the activation of the heater 12. The control unit (microcomputer 18) provides the gate of the triac 13 with a pulse signal serving as a trigger for activating the triac 13 based on the zero-cross timing of the AC voltage. If the triac 13 is not held in an activated state even though the trigger is received at the zero-cross timing, the microcomputer 18 delays the output timing of the pulse signal from the zero-cross timing while keeping the pulse width of the pulse signal constant until the triac 13 is held in an activated state. Accordingly, even under a freezing temperature such as −40° C., the operation of the triac 13 is controlled with a pulse width that is the same as that for a normal temperature. This ensures required characteristics and operation for a control rectifying element, such as the triac 13, even in a freezing environment without increasing the watt value of the breeder resistor 19 used in a power supply free of a transformer.

(2) The microcomputer 18 delays the output timing of the pulse signal by predetermined periods from the zero-cross timing whenever detecting the zero-cross timing. The temperature of the triac 13 and the amount of current flowing to the triac 13 determines the delay in the output timing of the pulse signal from the zero-cross timing required to hold the triac 13 in an activated state. However, the heater controller 10 would become complicated when obtaining the delay value from the temperature and current amount of the triac 13. Accordingly, in the preferred embodiment, the output of the pulse signal is delayed from the zero-cross timing by predetermined periods whenever detecting the zero-cross timing. This enables the triac 13 to be held in an activated state just by outputting the pulse signal for a certain number of times. Thus, the heater controller 10 has a simple structure and the control is simplified.

(3) After the triac 13 is held in the activated state by the pulse signal, the microcomputer 18 shortens the delay time td for outputting the pulse signal by predetermined periods (predetermined second period) whenever detecting the zero-cross timing. This activates the triac 13 near the zero-cross timing. Thus, the power consumption is reduced in comparison to when the delay from the zero-cross timing is constant.

(4) Changes in the output timing of the pulse signal are set with the product of the count value of the counter and the predetermined time Δt. This facilitates the structure.

(5) The triac 13 is used as a control rectifying element. This reduces power consumed for control execution in comparison to when using a thyristor as the control rectifying element.

It should be apparent to those skilled in the art that the present invention may be embodied in many other specific forms without departing from the spirit or scope of the invention. Particularly, it should be understood that the present invention may be embodied in the following forms.

The delay time td does not have to be set from the product of the count value of the counter and the predetermined time Δt. For example, the delay time td may be set by adding the predetermined time Δt to the previous delay time td.

The value of the predetermined time Δt for delaying the output timing of the pulse signal from the zero-cross timing may be varied whenever necessary in accordance with the ambient temperature at the point of time the microcomputer 18 initiates heater control.

If the control rectifying element is not held in an activated state by a pulse signal output from a microcomputer at the zero-cross timing, the delay time td of the pulse signal may be obtained through calculations. In this case, the microcomputer measures the ambient temperature (for example, with the thermistor 27) and calculates the delay time td to obtain the pulse signal that causes current, which is greater than or equal to the holding current corresponding to the measured temperature to flow to the current rectifying element. Such delay control shortens the time until the control rectifying element is held in an activated state in comparison to when delaying the pulse signal by predetermined periods upon detecting the zero-cross timing.

The delay time td may be set to zero after the temperature of the control rectifying element reaches the ambient temperature at which it is held in an activated state even if the pulse signal is output immediately after the zero-cross timing, or substantially in synchronism with the zero-cross timing.

The control rectifying element is not limited to the triac 13 and a thyristor may be used instead.

The present examples and embodiments are to be considered as illustrative and not restrictive, and the invention is not to be limited to the details given herein, but may be modified within the scope and equivalence of the appended claims.

What is claimed is:

1. A heater controller for connection to an AC power supply and for controlling a heater, the heater controller comprising:
a control rectifying element connectable to the heater and AC power supply in which the control rectifying element controls the supply of AC voltage to the heater; and
a control unit, connected to the control rectifying element, for outputting a pulse signal that serves as a trigger for holding the control rectifying element in an activated state based on a zero-cross timing of the AC voltage, with the pulse signal having a pulse width;
wherein when the control rectifying element is not held in an activated state by the pulse signal output from the control unit at the zero-cross timing, the control unit delays the output of the pulse signal from the zero-cross timing while keeping the pulse width of the pulse signal constant until the control rectifying element is held in an activated state.

2. The heater controller according to claim 1, wherein the control unit delays the output of the pulse signal from the zero-cross timing by predetermined first periods.

3. The heater controller according to claim 2, wherein the control unit delays the output of the pulse signal whenever detecting the zero-cross timing.

4. The heater controller according to claim 1, wherein after the control rectifying element is held in an activated state by the pulse signal, the control unit shortens the delay of the output of the pulse signal by predetermined second periods.

5. The heater controller according to claim 4, wherein after the control rectifying element is held in an activated state by the pulse signal, the control unit shortens the delay of the output of the pulse signal whenever detecting the zero-cross timing.

6. The heater controller according to claim 1, wherein:
the heater has a heater temperature; and
the control unit determines the heater temperature and an ambient temperature to delay the output of the pulse signal from the zero-cross timing when the ambient temperature is less than or equal to a first set temperature and the heater temperature is less than or equal to a predetermined temperature.

7. The heater controller according to claim 6, further comprising:
a counter for generating a count value that is incremented when the control rectifying element is not held in an activated state by the pulse signal, wherein the control unit delays the output of the pulse signal from the zero-cross timing in accordance with the count value of the counter.

8. The heater controller according to claim 7, wherein the control unit decrements the count value when the ambient temperature is greater than or equal to a second set temperature.

9. The heater controller according to claim 1, wherein after the control rectifying element is held in an activated state by the pulse signal, the control unit sets the delay of the output of the pulse signal to zero.

10. The heater controller according to claim 9, wherein:
the control rectifying element has a temperature; and
the control unit sets the delay of the output of the pulse signal to zero based on the temperature of the control rectifying element.

11. The heater controller according to claim 1, wherein the control rectifying element is a triac.

12. The heater controller according to claim 1, wherein:
the control rectifying element is held in an activated state based on holding current that is dependent on an ambient temperature; and
the control unit determines the ambient temperature and delays the output of the pulse signal from the zero-cross timing so that the pulse signal causes the holding current corresponding to the ambient temperature to flow to the control rectifying element.
